(19) United States
(12) Patent Application Publication
(10) Pub. No.: US 2007/0174235 A1
(43) Pub. Date: Jul. 26, 2007

(54) Method of using digital characters to compile information

(76) Inventor: Michael Gordon, Newport Beach, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/365,966

(22) Filed: Feb. 28, 2006

Related U.S. Application Data
(60) Provisional application No. 60/762,278, filed on Jan. 26, 2006.

(51) Int. Cl. G06F 17/30

(52) U.S. Cl. 707/2

(57) ABSTRACT

The present invention provides a method of using a digital character to compile information, comprising the step of providing a digital character that is configured to interactively gather user information and interacting with a user via the digital character in order to collect user information, wherein the digital character is configured to learn and embody preferences and tendencies of the user.

### CROSS-REFERENCE TO RELATED APPLICATIONS

This application claims priority from U.S. Provisional Patent Application No. 60/762,278, filed on Jan. 26, 2006, the contents of which are incorporated herein by reference in their entirety.

### FIELD OF THE INVENTION

The present invention is directed to digital icons or characters, and more particularly to, a method of using digital characters to compile information.

### BACKGROUND OF THE INVENTION

The Internet has become an exceptionally efficient tool for gathering consumer information. Many companies persistently target consumers using direct email and other forms of solicitations with the use of the Internet in combination with various database tools. However, consumers are becoming increasingly concerned with the collection and use of their personal information. For example, many consumers oppose direct marketing and sale of personal information such as purchasing habits without their consent or any benefit to them. Additionally, many consumers are averse to providing any information regarding purchasing habits and preferences.

In view of the above, there exists a need for a method of using software-based digital characters for interactively gathering consumer information.

There also exists a need for a method of using software-based digital characters for interactively gathering consumer information in combination with various research concepts and techniques such as conjoint analysis and conjoint measurement that may be employed to help model the digital icon's behavior in order to better serve the user.

In addition, there exists a need for a method of using a software-based digital character for interactively gathering user information, wherein the character comprises a digital alter ego of the user.

### SUMMARY OF THE INVENTION

In view of the foregoing, it is an object of the present invention to provide a method of using software-based digital characters for interactively gathering consumer information.

It is another object of the invention to provide a method of using software-based digital characters for interactively gathering consumer information in combination with various research concepts and techniques such as conjoint analysis and conjoint measurement that may be employed to help model the digital icon's behavior in order to better serve the user.

In addition, it is an object of the invention to provide a method of using a software-based digital character for interactively gathering user information, wherein the character comprises a digital alter ego of the user.

The preferred embodiment of the present invention is directed to a method of using a digital character to compile information, comprising the steps of providing at least one software-based digital character that is configured to interactively gather user information and interacting with a user via the digital character in order to collect user information, wherein the digital character is configured to learn and embody preferences and tendencies of the user. The user information comprises consumer information concerning user purchasing tendencies and user preferences, as well as user data, user trends and user research information.

According to an aspect of the invention, the digital character comprises a digital icon that functions as a digital friend of the user, wherein the digital character is configured to learn the likes, dislikes, tendencies, trends, ideas, goals and interests of the user. Essentially, the digital character embodies a cyber-world characterization with a functioning intelligence patterned after the user.

According to another aspect of the invention, the above-described method of using a digital character to compile information may further comprise the step of providing a digital advisor based upon one or more software applications that interacts with the user, wherein the digital advisor provides the user with direction, leadership, suggestions and the ability to exchange information.

According to a further aspect of the invention, the digital character is configured to develop into an alter ego of the user that embodies the personal characteristics and preferences of the user. The development of the digital character into the alter ego of the user is an incremental process that occurs over a period of time as an underlying software program gathers user information and applies the information to the characterization of the digital character. For example, backend programs such as “digital coach”, “digital counselor”, “digital designer”, “digital homemaker”, “digital golf instructor”, etc., may be built into a digital character based upon the personal makeup of the corresponding user. In this manner, users may assist in recreating themselves, and then the backend software builds upon this information using outside resources.

An additional aspect of the invention involves using the collected user information in conjunction with research techniques to model the behavior of the digital character in order to better serve the user, or to predict products and services that a user will choose and assess the weight the user will assign to various factors that underlie the user's decisions. Such research techniques may include: conjoint analysis, conjoint measurement; quantitative & qualitative marketing research; multi-attribute compositional models; Internet research; market modeling; relationship analysis; primary & secondary research techniques; applied sociology; applied psychology & applied cognition techniques; laws of comparative judgment; buyer decision modeling; online surveys; interviews; focus groups; multiattribute compositional models; statistical techniques that originated in mathematical psychology; techniques using algorithms; discrete choice and conjoint models; bundling research; ingredient screening and product optimization; market segmentation including latent class cluster analysis and grouping techniques; multivariate statistical analysis; multiple regression techniques; logical regression techniques; categorical analysis; factor analysis; cluster analysis; discriminant analysis; multidimensional scaling (MDS); canonical correlation; multivariate analysis of variance (MANOVA); analysis of variance (ANOVA); covariance structural models (LISREL) using both categorical and continuous data; independence techniques; common factor analysis; correspondence analysis; structural equation modeling (SEM); latent variable analysis; confirmatory factor analysis; polytopes; and/or stochastic modeling.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention is directed to software-based digital characters that are employed to interactively gather, sort and analyze consumer information, and then recommend various purchases of goods and/or services. These digital characters are also referred to herein as “digital icons”, “digital friends”, “animated characters” and “branded characters”. According to a preferred implementation of the invention, the digital characters may be accessed by users as part of an Internet website including computer software comprising machine readable or interpretable instructions for providing images of the digital characters and controlling their communication with various users. As would be appreciated by those of ordinary skill in the art, the digital characters may be accessed by other forms, channels, routes and distribution areas of cyber space without departing from the scope of the present invention. By way of example, the characters may be accessed via an Intranet, a mobile connection, a virtual private network (VPN), a local area network (LAN), a wide area network (WAN) and/or a home network.

The characters may comprise digital icons that function as digital friends that interact with users for the purpose of collecting data, trends and research information. In particular, the software is designed to collect information with respect to a user's likes, dislikes, tendencies, trends, ideas, goals and interests. As the software gathers information regarding a particular user, a digital coach or advisor interacts with the user to provide direction, leadership, suggestions and the exchange of information. During this process, the software behind the digital character “learns” about the user's characteristics such that it is able to assist in advising and mentoring the user. The digital coach preferably is able to make the user's life richer, more productive, more useful, more efficient and more opportunistic. This learning process is a direct result of the digital communication and character-based interaction between the user and the digital coach. In this manner, the digital coach acts as a friend and coach to the user, while simultaneously functioning as a research and data collection tool.

In accordance with the principles of the invention, a user may choose one of a plurality of digital characters to be her own digital character. Initially, the selected digital character will have its own personality since the digital character has not yet adapted its disposition to match that of the user. Over time, the software behind the digital character will learn the tendencies and characteristics of the user and may adapt the behavior of the digital character to mock that of the user. The user may also plug in one or more software applications to expedite the digital icon's adaptation to a particular user. By way of example, these software applications may include “cyber golfer”, “digital fashionista” and “how to eat right for your blood type”. According to further embodiments, the user may set a goal to be achieved in a particular area, wherein the digital friend helps the user achieve the goal by charting the user's daily path and comparing the actual path to a projected path for achieving the goal. In this way, the digital icon acts as a coach and an accountability partner in achieving the user's stated goals.

After a significant amount of interaction with the user, the digital character eventually becomes an alter ego of the user that embodies many of the personal characteristics and preferences of the user. The processing of becoming the alter ego of the user happens incrementally over a period of time as the software gathers user information and applies the information to the characterization of the digital icon. Eventually, the digital character becomes a digital “mini-me” of the corresponding user such that the digital character embodies a cyber-world characterization with a functioning intelligence patterned after the user. According to the invention backend programs such as “digital coach”, “digital counselor”, “digital designer”, “digital homemaker”, “digital golf instructor”, etc., may be built into a digital character based upon the personal makeup of the corresponding user. In this manner, users may assist in recreating themselves, such that the backend software builds upon this information using outside resources.

The present invention comprises a proactive, personalized and intelligent concierge in cyberspace that locates, receives and sorts information and offers from various sources in accordance with an individual user. Once the information is sorted, it may be analyzed, measured and/or modeled using one or more of the research concepts described below. Additionally, the present invention contemplates the development of numeric equations and languages based upon numeric values that allow the digital icons to effectively communicate with one another to aid in the analysis, measurement and/or modeling of the compiled information. Once the numeric equations and languages are established, users may pay to have their digital icons seek and gather information on their behalf, as well as make selected purchases of goods and services on their behalf. As such, the digital character comprises a proactive cyber seeker configured to act on behalf of the user.

According to additional embodiments of the invention, the software may permit a user to allow her corresponding digital icon to emulate, or to act on behalf of the user in cyberspace. The digital icon may be unrestrained or may be subject to one or more predetermined constraints. For example, the corresponding digital icon may be instructed to search for and purchase various goods and services that meet predetermined conditions. The digital character must first be allowed to establish the user's interest level in the various good and services by collecting the information and sorting it accordingly. In this manner, the digital icons do most of the work using the data supplied by numerous sources and the parameters set forth by individual users. These sources may include databases of information that help the user become more effective, more efficient, more beautiful, more attractive, more valuable, more interesting, richer, smarter, more relevant, more hip and/or more timely. In order to predict and facilitate the user's future, the collected information may further comprise various data based upon various tests, such as including personality tests, spiritual gifting tests and work traits tests.

The present invention also envisions a “virtual community” that is created around the digital icons. Within the virtual community, each digital character may act as a buyer for the user by performing various seeking, sorting and matching tasks based upon instructions from the user. Additionally, the digital character may employ different research concepts and mathematical modeling techniques, such as those that are described hereinbelow. Furthermore, an individual user, acting through their digital icon (buyer), may participate in a reverse auction wherein sellers bid against other sellers for buyer information and the right to solicit buyers for the goods and services that they have to offer. The reverse auction comprises an efficient and transparent procurement technique structured around lowest price, wherein sellers compete in real time by bidding lower as the auction unfolds. Buyers realize the benefit of receiving the lowest price, whereas sellers realize the benefits of transparency and increased market awareness.

Prior to conducting a reverse auction, sellers should be advised of the reverse auction details by ensuring the capability of all sellers to participate, answering seller inquiries to ensure they fully understand the process, deciding on an initial price, deciding on a minimum bid decrement (i.e. the amount by which sellers must reduce their bids), establishing a duration for the auction based upon the number of bidders and procurement complexity, and defining any extensions to be made if a bid is received close to the end of the auction. According to other embodiments of the present invention, digital icons may simply broker information instead of participating in reverse auctions. For example, digital icons may employ a refined search feature that disintermediates advertisement sales from online aggregators since the sellers may target buyers using a many-to-one approach inside the virtual community.

According to the invention, there are numerous research concepts and techniques that may be employed to help model the digital icon's behavior in order to better serve the user. Such concepts include, but are not limited to: (1) conjoint analysis; (2) conjoint measurement; (3) quantitative & qualitative marketing research; (4) multi-attribute compositional models; (5) Internet research; (6) market modeling; (7) relationship analysis; (8) primary & secondary research techniques; (9) applied sociology; (10) applied psychology & applied cognition techniques; (11) laws of comparative judgment; (12) buyer decision modeling; (13) online surveys; (14) interviews; (15) focus groups; (16) multiattribute compositional models; (17) statistical techniques that originated in mathematical psychology; (18) techniques using algorithms; (19) discrete choice and conjoint models; (20) bundling research; (21) ingredient screening and product optimization; (22) market segmentation including latent class cluster analysis and grouping techniques; (23) multivariate statistical analysis; (24) multiple regression techniques; (25) logical regression techniques; (26) categorical analysis; (27) factor analysis; (28) cluster analysis; (29) discriminant analysis; (30) multidimensional scaling (MDS); (31) canonical correlation; (32) multivariate analysis of variance (MANOVA); (33) analysis of variance (ANOVA); (34) covariance structural models (LISREL) using both categorical and continuous data; (35) independence techniques; (36) common factor analysis; (37) correspondence analysis; (38) structural equation modeling (SEM); (39) latent variable analysis; (40) confirmatory factor analysis; (41) polytopes; and/or (42) stochastic modeling.

Conjoint analysis predicts the products and/or services that a user will choose and assesses the weight the user will assign to various factors-that underlie the user's decisions. Consumers typically examine a wide range of features or attributes, and then make judgments or trade-offs to determine their final purchase choice. Conjoint analysis examines these trade-offs to determine the combination of attributes that will be most satisfying to the consumer. By using conjoint analysis, a company can determine the preferred features for their product or service and can identify the best advertising message by identifying the features that are most important in product choice.

Conjoint analysis may be used to determine the relative importance of each attribute of a plurality of attributes, as well as the relative value of each combination of attributes. If a product featuring the most favorable attributes is not feasible, then the conjoint analysis will identify the next most preferred alternative. In evaluating products, consumers will always make trade-offs. Conjoint analysis allows an examination of the trade-offs that people make in purchasing a product. By examining the results of a conjoint analysis, a product design may be selected that is the most appealing to a specific market. In addition, because conjoint analysis identifies important attributes, it can be used to create advertising messages that will be most persuasive. The importance of an attribute can be calculated by examining the range of utilities (that is, the difference between the lowest and highest utilities) across all levels of the attribute. That range represents the maximum impact that the attribute can contribute to a product.

Marketers can use the information from utility values to design products and/or services which come closest to satisfying important consumer segments. Conjoint analysis will identify the relative contributions of each feature to the choice process. This technique, therefore, can be used to identify market opportunities by exploring the potential of product feature combinations that are not currently available.

In addition to providing information on the importance of product features, conjoint analysis provides the opportunity to conduct computer choice simulations. Choice simulations reveal consumer preference for specific products defined by the researcher. Simulations can be done interactively on a microcomputer to quickly and easily look at all possible options. The researcher may, for example, want to determine if a price change of $50, $100, or $150 will influence consumer's choice. Also, conjoint will let the researcher look at interactions among attributes. For example, consumers may be willing to pay $50 more for a flight on the condition that they are provided with a hot meal rather than a snack.

In order to conduct a conjoint analysis, information must be collected from a sample of consumers. This data can be conveniently collected in locations such as shopping centers or by the Internet. A sample size of 400 is generally sufficient to provide reliable data for consumer products or services. Data collection involves showing respondents a series of cards that contain a written description of the product or service. If a consumer product is being tested then a picture of the product can be included along with a written description. Utilities can then be calculated and simulations performed to identify which products will be successful and which should be changed. Price simulations can also be conducted to determine sensitivity of the consumer to changes in prices.

As distinguished from conjoint analysis, conjoint measurement permits the use of rank or rating data when evaluating pairs of attributes or attribute profiles rather than single attributes. Based on this rank or rating input, the conjoint measurement procedures are applied to identify a mathematical function of the m brand attributes, which: (1) produces a set of interval scaled output; (2) best corresponds to the set of subjective evaluations of the brand alternatives made by the respondent; and (3) is either a categorical or polynomial function in the attributes for the rank order data.

The power of conjoint measurement involves the conversion of non-metric input into interval scaled output. The conjoint measurement model assumes the following: (1) the set of objects being evaluated is at least weakly ordered (may contain ties); (2) each object evaluated may be represented by an additive combination of separate utilities existing for the individual attribute levels; and (3) the derived evaluation model is interval scaled and comes as close as possible to recovering the original rank order [non-metric] or rating [metric] input data.

Discrete choice and conjoint models are advanced modeling techniques involving studies that focus upon price sensitivity, product design and market potential, wherein patterns of choices based on different product configurations are used to model how different consumers might respond to various configurations of product or service offerings. The results may be incorporated into a web-based interactive decision tool (IDT) or other known simulation program. Bundling research is used to determine preferred product or service features to be included in a product or service offer and at what price. This type of research may be used for menu optimization or the development of utility service plans.

Ingredient screening and product optimization is based on experimental designs to isolate the effects of different features, wherein the most effective features are then manipulated within an experimental design framework to identify an optimal consumer acceptance. Product optimization analyses are typically based on response surface models, conjoint analyses, and related statistical techniques. Market segmentation may involve latent class cluster analysis and other clustering and grouping techniques.

Multiple regression analysis is a common multivariate technique that looks at the relationship between a single metric dependent variable and two or more metric independent variables to determine the linear relationship with the lowest sum of squared variances. Multiple regression analysis is frequently used as a forecasting tool. Logistic regression analysis is a variation of multiple regression analysis that involves the prediction of an event with the goal of arriving at a probabilistic assessment of a binary choice. A contingency table is produced depicting whether the observed and predicted events match.

Discriminant analysis is designed to precisely classify observations or people into homogeneous groups, wherein a linear discriminant function is built and used to classify the observations. This type of analysis may be used to categorize people such as buyers and nonbuyers. MANOVA assesses the relationship between several categorical independent variables and two or more metric dependent variables, whereas ANOVA examines the differences between groups by using T tests for 2 means and F tests between 3 or more means.

Independence techniques are used to reduce the amount of variables in a research design in which there is no dependent variable and the independent variables are normal and continuous. Multicollinearity is generally preferred between the variables because the correlations are key to data reduction. Common factor analysis is employed to extract factors based on the shared variance of the factors and principal component analysis. The purpose of common factor analysis is to look for latent factors, whereas the purpose of principal components analysis is to find the fewest number of variables that explain the most variance.

Cluster analysis is used to divide a large data set to meaningful subgroups of individuals or objects, wherein the division is accomplished on the basis of similarity of the objects across a set of specified characteristics. Primary clustering methods included hierarchical, non hierarchical and combinations thereof. Cluster analysis is an excellent tool for market segmentation. Multidimensional scaling (MDS) is employed to transform consumer judgments of similarity into distances represented in multidimensional space. Correspondence analysis is used for dimensional reduction of object ratings on a set of attributes, which results in a perceptual map of the ratings. However, unlike MDS, both independent variables and dependent variables are examined at the same time. Correspondence analysis is a compositional technique that is most useful when there are many attributes and many companies under consideration.

Canonical correlation is a multivariate technique that correlates several independent variables and several dependent variables simultaneously. Structural equation modeling (SEM) examines multiple relationships between sets of variables simultaneously. SEM represents a family of techniques, including LISREL, latent variable analysis and confirmatory factor analysis. SEM is frequently used to evaluate multi-scaled attributes or to build summated scales. Stochastic modeling is a statistical process that uses probability and random variables to predict a range of probable outcomes. Stochastic modeling including stochastic quantum physics may be used in the design or enabling of the technology of the present invention.

According to additional embodiments of the invention, the information compiled from the digital character and user interaction can also be used for a variety of purposes other than targeting market research. Such purposes include, but not limited to, marketing promotions, public relations activity and advertising activity.

In accordance with the principles of the present invention, a preferred embodiment of a method of using a digital character to compile information will now be described. An initial step of the method comprises providing at least one digital character that is configured to interactively gather user information. The next step involves interacting with a user via the digital character in order to collect user information, wherein the digital character is configured to learn and embody preferences and tendencies of the user. The user information comprises consumer information concerning user purchasing tendencies and user preferences, as well as user data, user trends and user research information.

The method of using a digital character to compile information may further comprise the step of providing a digital advisor that interacts with the user, wherein the digital advisor provides the user with direction, leadership, suggestions and the ability to exchange information. Additionally, the method may further include the steps of utilizing conjoint analysis to model the behavior of the digital character in order to better serve the user and utilizing conjoint analysis to predict products and services that a user will choose and assess the weight the user will assign to various factors that underlie the user's decisions, and utilizing conjoint measurement to predict products and services that a user will choose and assess the weight the user will assign to various factors that underlie the user's decisions.

In accordance with the above-described method, the digital character may comprise a digital icon that functions as a digital friend of the user, wherein the digital character is configured to learn the likes, dislikes, tendencies, trends, ideas, goals and interests of the user. In essence, the digital character embodies a cyber-world characterization with a functioning intelligence patterned after the user. Furthermore, the digital character may be configured to develop into an alter ego of the user that embodies the personal characteristics and preferences of the user. The development of the digital character into the alter ego of the user is an incremental process that occurs over a period of time as an underlying software program gathers user information and applies the information to the characterization of the digital character.

Additional steps for the above-identified method of using a digital character to compile information may comprise: (1) sorting and analyzing the user information; and (2) recommending various purchases of goods and services to the user based upon the analysis of user information. Further, the digital character preferably is configured to report the sorted and analyzed information to the user.

Thus, it is seen that a method of using digital characters to compile information is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A method of using a digital character to compile information, comprising:
providing a digital character that is configured to interactively gather user information; and
interacting with a user via the digital character in order to collect user information;
wherein the digital character is configured to learn and embody preferences and tendencies of the user.

2. The method of claim 1, wherein the user information comprises consumer information concerning user purchasing tendencies and user preferences.

3. The method of claim 1, wherein the user information comprises user data, user trends and user research information.

4. The method of claim 1, wherein the digital character comprises a digital icon that functions as a digital friend of the user.

5. The method of claim 1, wherein the digital character is configured to learn the likes, dislikes, tendencies, trends, ideas, goals and interests of the user.

6. The method of claim 1, further comprising the step of providing a digital advisor that interacts with the user.

7. The method of claim 6, wherein the digital advisor provides the user with direction, leadership, suggestions and the ability to exchange information.

8. The method of claim 1, wherein the digital character is configured to develop into an alter ego of the user that embodies the personal characteristics and preferences of the user.

9. The method of claim 8, wherein the development of the digital character into the alter ego of the user is an incremental process that occurs over a period of time as an underlying software program gathers user information and applies the information to the characterization of the digital character.

10. The method of claim 1, wherein the digital character embodies a cyber-world characterization with a functioning intelligence patterned after the user.

11. The method of claim 1, further comprising the step of utilizing conjoint analysis to model the behavior of the digital character in order to better serve the user.

12. The method of claim 1, further comprising the step of utilizing conjoint analysis to predict products and services that a user will choose and assess the weight the user will assign to various factors that underlie the user's decisions.

13. The method of claim 1, further comprising the step of utilizing conjoint measurement to predict products and services that a user will choose and assess the weight the user will assign to various factors that underlie the user's decisions.

14. The method of claim 1, further comprising the step of permitting the digital character to emulate the user in cyberspace.

15. The method of claim 14, wherein user emulation is subject to one or more predetermined constraints.

16. The method of claim 1, further comprising the step of sorting and analyzing the user information.

17. The method of claim 16, further comprising the step of recommending various purchases of goods and services to the user based upon the analysis of user information.

18. The method of claim 16, wherein the digital character is configured to report the sorted and analyzed information to the user.

19. The method of claim 1, wherein the digital character comprises a proactive cyber seeker configured to act on behalf of the user.

20. The method of claim 1, wherein the digital character is constantly activated.

21. The method of claim 1, wherein the collected user information is used in conjunction with a research technique chosen from the group consisting of: quantitative & qualitative marketing research; multi-attribute compositional models; Internet research; market modeling; relationship analysis; primary & secondary research techniques; applied sociology; applied psychology & applied cognition techniques; laws of comparative judgment; buyer decision modeling; online surveys; interviews; focus groups; multiattribute compositional models; statistical techniques that originated in mathematical psychology; techniques using algorithms; discrete choice and conjoint models; bundling research; ingredient screening and product optimization; market segmentation including latent class cluster analysis and grouping techniques; multivariate statistical analysis; multiple regression techniques; logical regression techniques; categorical analysis; factor analysis; cluster analysis; discriminant analysis; MDS; canonical correlation; MANOVA; ANOVA; LISREL; independence techniques; common factor analysis; correspondence analysis; SEM; latent variable analysis; confirmatory factor analysis polytopes; and stochastic modeling.

22. The method of claim 1, further comprising the step of providing a virtual community that is created around the digital characters, wherein the user may control buying and selling of goods and services while acting through their digital character in a reverse auction style format.
